(19) United States
(12) Patent Application Publication
(10) Pub. No.: US 2018/0094337 A1
(43) Pub. Date: Apr. 5, 2018

(54) CAST ALUMINUM ALLOY, METHOD FOR PRODUCING AN ENGINE COMPONENT, ENGINE COMPONENT, AND USE OF A CAST ALUMINUM ALLOY TO PRODUCE AN ENGINE COMPONENT

(71) Applicant: FEDERAL-MOGUL NURNBERG GMBH, NURNBERG (DE)

(72) Inventors: KLAUS LADES, NURNBERG (DE); ROMAN MORGENSTERN, HEILSBRONN (DE)

(21) Appl. No.: 15/563,786

(22) PCT Filed: Mar. 21, 2016
(86) PCT No.: PCT/EP2016/056123

§ 371 Date: Oct. 2, 2017

(30) Foreign Application Priority Data
Apr. 1, 2015 (DE) 10 2015 205 895.6

(51) Int. Cl. C22C 21/02

(52) U.S. Cl. CPC C22C 21/02; F02F 3/0084

(57) ABSTRACT

The application relates to a cast aluminum alloy, to a method for producing an engine component, in particular a piston for an internal combustion engine, wherein a cast aluminum alloy is cast in the gravity permanent-mold casting method, to an engine component, in particular a piston for an internal combustion engine, at least partially consisting of a cast aluminum alloy, and to the use of a cast aluminum alloy to produce an engine component, in particular a piston for an internal combustion engine. The cast aluminum alloy consists of the following alloying elements: silicon: 9.0 wt % to<10.5 wt %, nickel: 0.8 wt % to<1.9 wt %, copper: 1.8 wt % to<3.6 wt %, magnesium: 0.5 wt % to 1.8 wt %, iron: 0.9 wt % to<1.4 wt %, zirconium and/or vanadium: in each case, 0.05 to<=0.3 or 0.2%, respectively, manganese: up to<=0.4 wt %, titanium: up to<=0.15 wt %, phosphorus: up to<=0.05 wt %, and aluminum and unavoidable impurities as the remainder.

### TECHNICAL FIELD

The present invention relates to a cast aluminum alloy, a method for producing an engine component, in particular a piston for an internal combustion engine, in which a cast aluminum alloy is cast using the gravity die casting method, an engine component consisting at least partially of a cast aluminum alloy, and the use of a cast aluminum alloy to produce such an engine component.

### PRIOR ART

In recent years, there has been a growing demand for particularly economical and thus ecological means of transport, which have to meet high consumption and emission requirements. There has furthermore always been the need to design engines to be as high performance and low in consumption as possible. Pistons that can be used at increasingly higher combustion temperatures and combustion pressures, which is essentially made possible by increasingly higher performance piston materials, are a decisive factor for the development of high-performance and low-emission internal combustion engines.

A piston for an internal combustion engine fundamentally has to have a high heat resistance and must at the same time be as light and strong as possible. Thereby of particular importance is how the microstructural distribution, the morphology, the composition and the thermal stability of highly heat-resistant phases are configured. An optimisation in this respect normally takes into consideration a minimal content of pores and oxide inclusions.

The sought-after material must be optimised both as regards isothermal fatigue strength (HCF) and as regards thermo-mechanical fatigue strength (TMF). In order to optimally configure the TMF, the finest possible microstructure of the material should always be aimed for. A fine microstructure reduces the risk of the occurrence of microplasticity or microcracks at relatively large primary phases (in particular at primary silicon precipitates) and thus also the risk of crack, initiation and crack growth.

Under TMF stress, microplasticities and/or microcracks, which can considerably reduce the lifespan of the piston material, occur at relatively large primary phases, in particular at primary silicon precipitates, owing to the different coefficients of expansion of the individual components of the alloy, namely the matrix and the primary phases. In order to increase the lifespan, it is known to keep the primary phases as small as possible.

In particular high-alloy, near eutectic or hypereutectic aluminum/silicon alloys have favourable mechanical properties at high operating temperatures. The phase size must thereby be limited with regard to the primary silicon and the resulting intermetallic phases.

DE 10 2011 083 969 A1 discloses in this regard a method for producing an engine component, in particular a piston for an internal combustion engine, in which an aluminum alloy is cast using the gravity die casting method. The aluminum alloy thereby comprises the following alloy elements: silicon: 6% by weight to 10% by weight, nickel: 1.2% by weight to 2% by weight, copper: 8% by weight to 10% by weight, magnesium; 0.5% by weight to 1.5% by weight, iron: 0.1% by weight to 0.7% by weight, manganese: 0.1% by weight to 0.4% by weight, zirconium: 0.2% by weight to 0.4% by weight, vanadium: 0.1% by weight to 0.3% by weight, titanium: 0.1% by weight to 0.5% by weight. However, high concentrations of the expensive element copper are required in order to produce the highly heat resistant alloy.

For engine components that can withstand high thermal stresses, conventional cast aluminium alloys similarly normally require between 5 and 7% by weight for the sum of the alloy elements copper and nickel as well as 11 to 13% by weight of silicon. The high silicon content thereby increases the risk of large and numerous primary silicon precipitates.

### DESCRIPTION OF THE INVENTION

One object of the present invention is to provide a highly heat resistant cast aluminum alloy, which can be produced in a cost effective manner.

This object is solved by the alloy according to claim 1. Preferred embodiments of the invention can be found in the sub-claims relating thereto.

A cast aluminum alloy consisting of the alloy elements

Silicon: 9.0% by weight to<10.5% by weight,

Nickel: 0.8% by weight to<1.9% by weight,

Copper: 1.8% by weight to<3.6% by weight,

Magnesium; 0.5% by weight to 1.8% by weight,

Iron: 0.9% by weight to<1.4% by weight,

Zirconium

and/or vanadium: each 0.05 to<=0.3, respectively 0.2% by weight,

Manganese: to<=0.4% by weight,

Titanium: to<=0.15% by weight,

Phosphorus: to<=0.05% by weight,

with aluminum and unavoidable impurities constituting the rest, has particularly favourable properties as regards heat resistance. At least one of the elements zirconium and vanadium is present, namely at a concentration of up to 0.3% by weight in the case of zirconium and 0.2% by weight in the case of vanadium, whereby these can be replaced in the above list and in patent claim 1 also by “zirconium to<=0.3% by weight, vanadium to<=0.2% by weight”.

The concentration according to the invention of the alloy element iron thereby leads to a high proportion of inter-metallic phases. However, by means of fine adjustment in respect of the further alloy elements, in particular copper and nickel, the formation of large, plate-like intermetallic phases is prevented. The latter restrict both castability as well as the strength and durability of a component produced from this material. The formed intermetallic phases are instead finely distributed, highly heat resistant as well as thermally stable and therefore act as strengthening precipitates. This leads to favourable properties as regards the isothermal fatigue strength and the thermomechanical fatigue strength.

Furthermore, the increased tolerance threshold for iron as compared to conventional aluminum/silicon alloys leads the flexibility as regards the useable raw materials For example, inexpensive scrap metals which, until now, could not be recycled owing to their iron content can be used to produce the alloy according to the invention.

The relatively low contents of copper and nickel thereby also advantageously reduce the overall costs of alloy production since they are among the most expensive alloy elements, and thus any (partial) substitution of these two elements leads to considerable cost savings.

The reduction of the silicon concentration as compared to conventional aluminum/silicon alloys furthermore advantageously leads to an alloy having fewer and smaller primary silicon phases, and thus the susceptibility to crack initiation and crack growth in particular under TMF stress is greatly reduced.

The discovered cast aluminum alloy is advantageously produced according to the invention using the gravity die casting method.

An engine component, in particular a piston for an internal combustion engine, preferably consists at least partially of one of the cast aluminium alloys according to the invention. Such an engine component according to the invention has a high heat resistance. In a piston produced in accordance with the invention, there is furthermore only a very small amount of primary silicon in the thermally highly-stressed bowl rim area thereof, and thus the alloy leads in particular to a very high heat resistance of a piston produced in accordance with the invention.

A further aspect of the invention is the preferred use of the cast aluminum alloy as described above for the production of an engine component, in particular a piston of an internal combustion engine.

1. A cast aluminum alloy, consisting of the following alloy elements:
Silicon: 9.0% by weight to<10.5% by weight,
Nickel: 0.8% by weight to<1.9% by weight,
Copper: 1.8% by weight to<3.6% by weight,
Magnesium: 0.5% by weight to 1% by weight,
Iron: 0.9% by weight to<1.4% by weight,
Zirconium
and/or vanadium: each 0.05 to<=0.3, respectively 0.2% by weight,
Manganese: to<=0.4% by weight,
Titanium: to<=0.15% by weight.
Phosphorus: to<0.05% by weight,
with aluminum and unavoidable impurities constituting the rest.

2. The cast aluminum alloy according to claim 1, wherein it contains 9.0% by weight to 9.5% by weight or 9.5% by weight to<10.5% by weight of silicon.

3. The cast aluminum alloy according to claim 1 wherein it contains 1.0% by weight to<1.5% by weight of nickel.

4. The cast aluminum alloy according to claim 1, wherein it contains>3.0% by weight to<3.6% by weight of copper.

5. The cast aluminum alloy according to claim 1, wherein it contains>0.5% by weight to<0.9% by weight of magnesium.

6. The cast aluminum alloy according to claim 1, wherein it contains 0.9% by weight to 1.1% by weight of iron.

7. The cast aluminum alloy according to claim 1, wherein it contains 0.2% by weight to 0.4% by weight of manganese.

8. A method of producing an engine component using the gravity die casting method, in particular a piston for an internal combustion engine, characterised in that a cast aluminum alloy is cast according to one of claim 1.

9. An engine component, in particular a piston for an internal combustion engine, characterised in that it consists at least partially of a cast aluminum alloy according to one of claim 1.

10. (canceled)
